(19) United States
(12) Patent Application Publication
(10) Pub. No.: US 2007/0185882 A1
(43) Pub. Date: Aug. 9, 2007

(54) Method and system for selective tracking of semantic web data using distributed update events

(75) Inventors: Joseph P. Betz, Arlington, MA (US); Christopher R. Vincent, Arlington, MA (US)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 11/348,194

(22) Filed: Feb. 6, 2006

(51) Int. Cl. G06F 17/30

(52) U.S. Cl. 707/10

(57) ABSTRACT

Disclosed are a method of and system for selective tracking of semantic web data. The method comprises the steps of providing a set of semantic web statements, identifying one or more subsets of said set of semantic web statements, and storing said one or more subsets on a given computer system. One or more trackers are established, with each of said trackers being associated with a respective one of said subsets; and when updates to semantic web statements in said set are issued, said one or more trackers are used to identify which ones of said updates are updates to semantic web statements in said one or more subsets. Preferably, each of the trackers is able to determine from a single statement update event if that statement is in the subset associated with said each tracker.

### BACKGROUND OF THE INVENTION

1. Field of the Invention

This invention generally relates to semantic web technology, and more specifically, to methods and systems for selective tracking of semantic web data using distributed update events. Even more specifically, the invention relates to such methods and systems that are particularly well suited for use with the Resource Description Framework (RDF) language.

2. Background Art

RDF is a language used to represent information, particularly meta data, about resources available in the World Wide Web. For example, RDF may be used to represent copyright or licensing information about a document on the Web, or the author and title of a particular Web page. RDF can also be employed for representing data or meta data about items or matters that can be identified on the World Wide Web even though these items cannot be directly retrieved from the Web. Examples of these latter items may include data about a user's Web preferences, and information, such as the price and availability, of items for sale at on-line shopping facilities. Specifications for RDF are established by the World Wide Web Consortium. The RDF specification also describes how to serialize RDF data for use in web services, etc. (e.g. RDF/XML).

RDF uses identifiers, referred to as Uniform Resource Identifiers, or URIs, and is based on a specific terminology. An RDF statement includes a subject, a predicate and an object. The subject identifies the thing, such as person or Web page, that the statement is about. The predicate identifies the property or characteristic, such as title or owner, of the subject of the RDF statement, and the object identifies a value of that property or characteristic. For example, if the RDF statement is about pet owners, the subject might be “owner,” the predicate could be “name,” and the object could be “Joe.” This format, among other advantages, allows RDF to represent statements as a graph of nodes and arcs. In the graph, the subjects and objects may be represented by, for example, ovals, circles or squares, or some combination thereof, while the predicates of the RDF statements may be represented by arcs or arrows connecting the subject of each statement with the object of the statement.

An important feature of RDF is that it provides a common framework for expressing information. This allows this information to be exchanged among applications without losing any meaning of the information. Because of this common framework, application developers can utilize the availability of common tools and parsers to process RDF information.

A number of RDF storage systems are built on top of relational databases. Conventional semantic web infrastructure tends to assume that all data is local (immedately accessible) to application code, and that the amount of data is such that application code can reasonably process events for all updates occurring in the entire RDG graph.

### SUMMARY OF THE INVENTION

An object of this invention is to track selectively semantic web data using distributed update events.

Another object of the present invention is to use application code to specify a sub-graph, of a graph of semantic web statements, to be replicated locally and to recieve update events on only those statements in the sub-graph.

A further object of the invention is to initialize trackers that are used to keep a sub-graph of semantic web statements up to date.

These and other objectives are attained with a method of and system for selective tracking of semantic web data. The method comprises the steps of providing a set of semantic web statements, identifying one or more subsets of said set of semantic web statements, and storing said one or more subsets on a given computer system. One or more trackers are established, with each of said trackers being associated with a respective one of said subsets; and when updates are issued to semantic web statements in said set, said one or more trackers are used to identify which ones of said updates are updates to semantic web statements in said one or more subsets. Preferably, each of the trackers is able to determine from a single statement update event if that statement is in the subset associated with said each tracker.

The preferred architecture of this invention allows application code to specify distributed application schemers for RDF, called “trackers,” which match particular sets of statements. In order to operate efficiently, these trackers are preferably able to select on statements individually, i.e., determine from a single statement update event if that statement should be included in the sub-graph. Therefore, any special information that the update managers include in statement update events (for example, named graphs or other providence information) can be utilized by special trackers.

Once a tracker has been initialized by application code and passed to its local model, its sub-graph is kept up to date by a combination of synchronous RDF queries and asynchronous update manager events. This includes statements being added or removed due to changes which qualify/disqualify them from one or more trackers.

When an RDF query is run against the local model, only statements matching one of its active trackers are considered. If the application code wishes to query the global RDF graph, it explicitly runs the query against the server model client interface. The application code may add “transient,” or local-only, statements to the local model, but changes to the global graph are made by explicitly updating the server model. Both the server model and the local model may implement essentially the same interface, e.g., the Jena RDF model interface or the semantic toolkit interface available from the International Business Machines Corporation.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 shows a computer system that may be used to practice this invention.

FIG. 2 illustrates a basic graph structure for an RDF statement.

FIG. 3 illustrates a larger graph having multiple RDF statements.

FIG. 4 depicts a sub-graph of the graph of FIG. 3.

FIG. 5 is an overview of the operation of the client of the computer system of FIG. 1.

FIG. 6 shows a routine for initializing a tracker object.

### DETAILED DESCRIPTION OF THE PREFERRED EMBODIMENTS

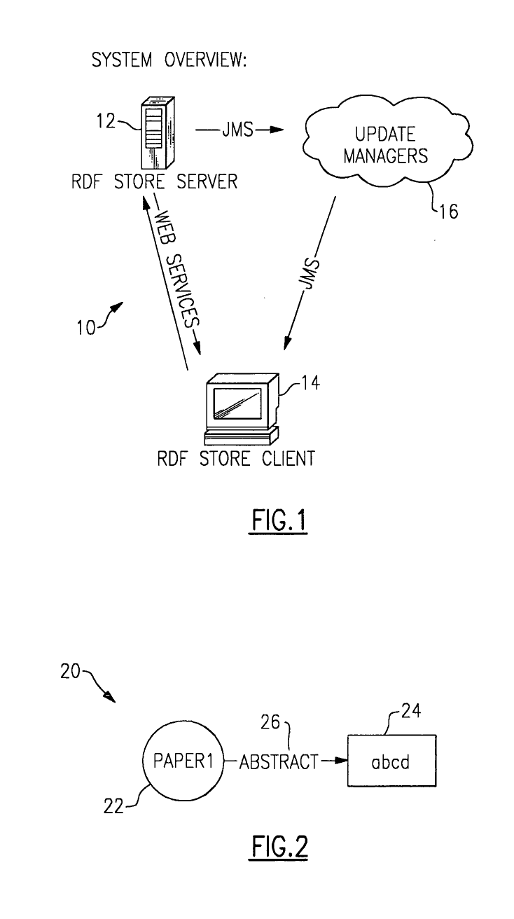

FIG. 1 illustrates a computer system 10 that may be used in the practice of this invention. In particular, FIG. 1 shows a server computer 12, a client computer 14, and a plurality of update managers 16. The devices of system 10 are connected together by any suitable network. Preferably, this network may be, for example, the Internet, but could also be an intranet, a local area network, a wide area network, or other networks. Also, as will be understood by those of ordinary skill in the art, system 10 may include additional servers, clients and other devices not shown in FIG. 1.

Any suitable server 12 may be used in system 10, and for example, the server may be an IBM RS/6000 server. Also, the clients 14 of the system may be, for instance, personal computers, laptop computers, servers, workstations, main frame computers, or other devices capable of communicating over the network. Likewise, the devices of system 10 may be connected to the network using a wide range of suitable connectors or links, such as wire, fiber optics or wireless communication links.

As mentioned above, in the depicted example, the devices of system 10 may be connected together via the Internet, which is a worldwide collection of networks and gateways that use the TCP/IP suite of protocols to communicate with one another. In the operation of system 10, server 12 provides data and applications to the clients. Among other functions, the server and the clients store semantic web statements such as RDF statements. For this reason, as depicted in FIG. 1, server 12 is referred to as an RDF store server, and clients 14 are referred to as RDF store clients.

The update managers 16 of system 10 are used to distribute updates to those semantic web statements. The update managers subscribe to statement updates based on patterns provided by their clients, and listen for all transaction completion messages. Any suitable update managers and any suitable procedure for broadcasting update events may be used in the practice of this invention. For example, suitable update managers and suitable procedures for broadcasting update events are described in copending application no. (Attorney Docket POU920050061US1), for “System And Method For Scalable Distribution Of Semantic Web Updates,” filed ______, the disclosure of which is hereby incorporated herein in its entirety by reference. Suitable update managers are also described in copending application no. (Attorney Docket no. POU920050059US1) for “System And Method For Tracking And Storing Semantic Web Revision History,” filed ______, the disclosure of which is hereby incorporated herein in its entirety by reference.

A number of RDF storage systems are built on top of relational databases. Suitable relational databases are disclosed, for example, in copending application no. (Attorney Docket POU920050098US1) for “Method And System For Controlling Access To Semantic Web Statements,” filed ______, and copending application no. (Attorney Docket POU920050099US1), for “Method And System For Efficently Storing Semantic Web Statements In A Relational Database,” filed—______ ,the disclosures of which are hereby incorporated herein in their entireties by reference.

As mentioned above, an RDF statement includes a subject, a predicate and an object. The subject identifies the thing that the statement is about, the predicate identifies a property or characteristic of the subject of the RDF statement, and the object identifies a value of that property or characteristic. This format allows RDF statements to be represented as a graph of nodes and arcs, and FIG. 2 illustrates a simple graph of an RDF statement 20. In this graph, the subject, object and predicate are represented at, 22, 24 AND 26 respectively.

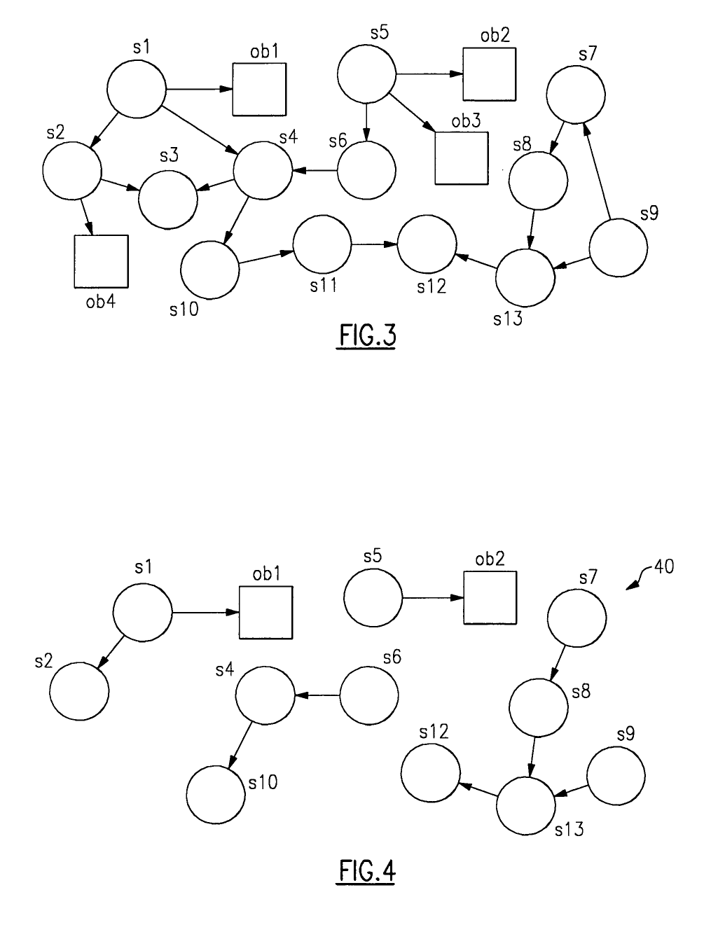

RDF statements can be more complex and, in particular, can be interconnected, with several statements having the same subject or the same object, and FIG. 3 shows a large, more complex RDF graph 30. In particular, graph 30 includes a series of RDF statements, including subjects S1-S13 and objects ob1-ob4.

Conventional semantic web infrastructure tends to assume that all data is local (immediately accessible) to application code, and that the amount of data is such that the application code can reasonably process events for all updates occurring in the entire RDF graph. The present invention provides a system where application code may specify a sub-graph to be replicated locally (in memory or on a local database) and receive update events on only those statements.

The preferred architecture of this invention allows application code to specify distributed application schemers for RDF, called “trackers,” which match particular sets of statements. In order to operate efficiently, these trackers should be able to select on statements individually, i.e., determine from a single statement update event if that statement should be included in the sub-graph. Therefore, any special information that the update managers include in statement update events (for example, named graphs or other providence information) can be utilized by special trackers.

Once a tracker has been initialized by application code and passed to its local model, its sub-graph is kept up to date by a combination of synchronous RDF queries and asynchronous update manager events. This includes statements being added or removed due to changes which qualify/disqualify them from one or more trackers.

When an RDF query is run against the local model, only statements mathching one of its active trackers are considered. If the application code wishes to query global RDF graph, it explicitly runs the query against the server model client interface. The application code may add “transient,” or local-only, statements to the local model, but changes to the global graph are made by explicitly updating the server model.

Both the server model and the local model may implement essentially the same interface, e.g., the Jena RDF model interface or the semantic toolkit interface available from the International Business Machines Corporation.

For example, the store server may contain the large RDF graph of FIG. 3, and tracker objects may be used to specify which statements will be stored/tracked locally. The local store contains the sub-graph, for example as illustrated at 40 in FIG. 4, made up of only the selected statements. In particular, graph 30 includes subjects S1, S2, S4, S5, S6, S7, S8, S9, S10, S12 and S13, and objects obl and ob2. It may be noted that some nodes of the sub-graph are no longer reachable.

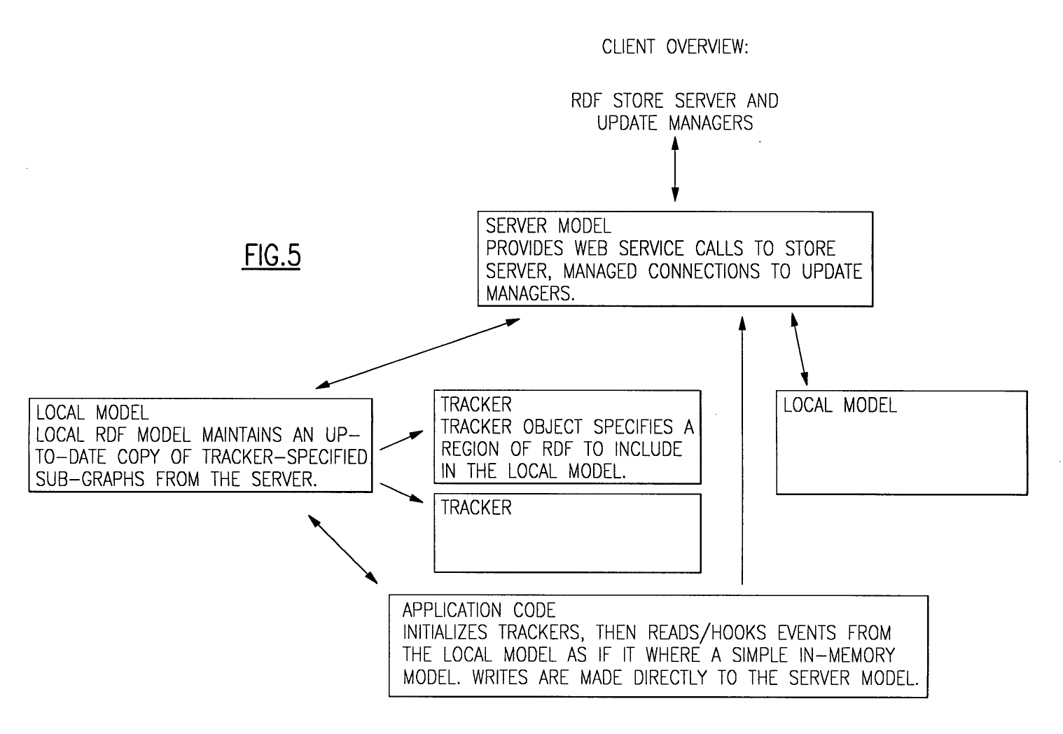

FIG. 5 shows an overview of the operation of client computer 14. As illustrated in this FIG., the server model provides web service calls to the store server 12, and manages connections to the update manager 16. Each local model maintains an up-to-date copy of tracker-specified sub-graphs from the server. Each tracker object specifies a region of RDF to include in the local model. The application code initializes trackers, and then reads/hooks events from the local model as if it were a simple in-memory model. Writes are made directly to the server model.

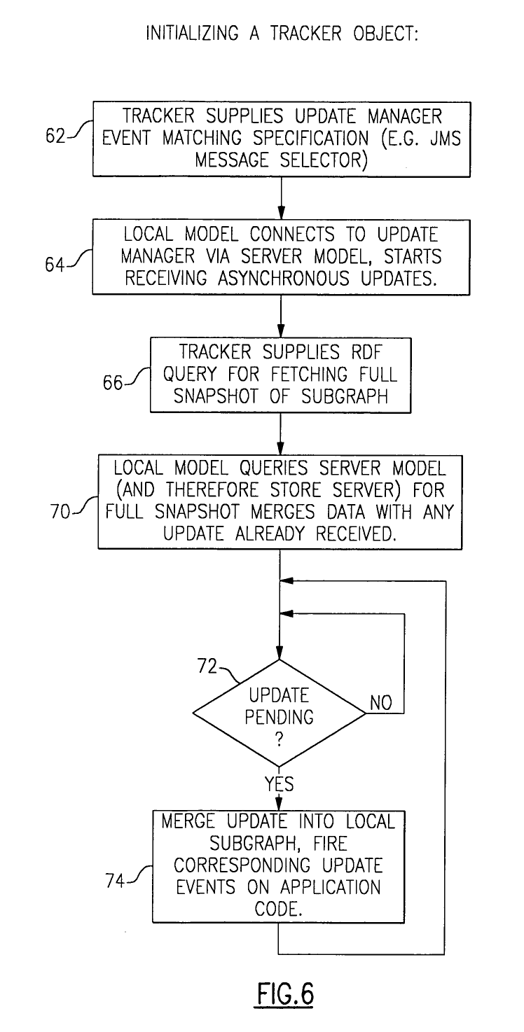

FIG. 6 shows a procedure for initializing a tracker. At step 62, the tracker supplies the update manager with event matching specification, and, for example, JMS message selector may be used to do this. Then, at step 64, the local model connects to the update manager via the server model, and the local model begins to receive asynchronous updates. At step 66, the tracker supplies an RDF query for fetching a full snapshot of a sub-graph. Next, at step 70, the local model queries the server model (and in this way queries the store server) for that full snapshot of the sub-graph, and the local model merges data with any updates already received.

As represented by step 72, the routine then waits for an update, and when an update is received, the routine moves on to step 74. At this step, the update is merged into the local sub-graph, and corresponding update events are fired on application code. When step 74 is completed, the routine returns to step 72 and waits for the next update.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention can also be embodied in a computer program product, which comprises all the respective features enabling the implementation of the method described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of selective tracking of semantic web data, comprising the steps of:
providing a set of semantic web statements;
identifying one or more subsets of said set of semantic web statements;
storing said one or more subsets on a given computer system;
establishing one or more trackers, each of said trackers being associated with a respective one of said subsets;
issuing updates to semantic web statements in said set; and
using said one or more trackers to identify which ones of said updates are updates to semantic web statements in said one or more subsets.

2. The method according to claim 1, wherein each of the trackers is able to determine from a single statement update event if that statement is in the subset associated with said each tracker.

3. The method according to claim 1, wherein the step of identifying one or more subset of said set of semantic web statements includes the step of using said given computer system to identify said one or more subsets.

4. The method according to claim 3, wherein the step of establishing one or more trackers includes the step of using said given computer system to establish said one or more trackers.

5. The method according to claim 1, wherein:
the providing step includes the step of representing said set of semantic web statements as a graph; and
the step of identifying one or more subsets of said set includes the step of identifying a sub-graph of said graph.

6. The method according to claim 1, wherein:
the given computer is a client computer;
the step of providing a set of semantic web statements includes the step of storing said set of semantic web statements on a server computer; and
the step of storing said one or more subsets on the given computer system includes the step of, said client computer using said one or more trackers to obtain said one or more subsets from the server computer.

7. A computer system for selective tracking of semantic web data, said computer system including instructions for:
accessing a set of semantic web statements;
receiving one or more subsets of said set of semantic web statements;
storing said one or more subsets on said computer system;
accessing one or more trackers, each of said trackers being associated with a respective one of said subsets;
receiving updates to semantic web statements in said set; and
using said one or more trackers to identify which ones of said updates are updates to semantic web statements in said one or more subsets.

8. The computer system according to claim 7, wherein each of the trackers is able to determine from a single statement update event if that statement is in the subset associated with said each tracker.

9. The computer system according to claim 7, wherein the instructions for receiving said one or more subset of said set of semantic web statements includes instructions for identifying said one or more subsets.

10. The computer system according to claim 9, wherein the instructions for accessing said one or more trackers includes include instructions for establishing said one or more trackers.

11. The computer system according to claim 7, wherein said set of semantic web statement are represented as a graph, and the instructions for receiving said one or more subsets of said set include instructions for identifying a sub-graph of said graph.

12. The computer system according to claim 7, wherein the computer system is a client computer and the semantic web statements are stored on a separate, server computer, and
the instructions for receiving said one or more subsets include instructions for using said one or more trackers to obtain said one or more subsets from the server computer.

13. A program storage device readable by machine, tangibly embodying a program of instructions executable by the machine to perform method steps for selective tracking of semantic web data, said method steps comprising:
providing a set of semantic web statements;
identifying one or more subsets of said set of semantic web statements;
storing said one or more subsets on a given computer system;
establishing one or more trackers, each of said trackers being associated with a respective one of said subsets;
issuing updates to semantic web statements in said set; and
using said one or more trackers to identify which ones of said updates are updates to semantic web statements in said one or more subsets.

14. The program storage device according to claim 13, wherein each of the trackers is able to determine from a single statement update event if that statement is in the subset associated with said each tracker.

15. The program storage device according to claim 13, wherein the step of identifying one or more subset of said set of semantic web statements includes the step of using said given computer system to identify said one or more subsets.

16. The program storage device according to claim 15, wherein the step of establishing one or more trackers includes the step of using said given computer system to establish said one or more trackers.

17. The program storage device according to claim 13, wherein:
the providing step includes the step of representing said set of semantic web statements as a graph; and
the step of identifying one or more subsets of said set includes the step of identifying a sub-graph of said graph.

18. The program storage device according to claim 13, wherein the given computer is a client computer, and wherein:
the step of providing a set of semantic web statements includes the step of storing said set of semantic web statements on a server computer; and
the step of storing said one or more subsets on the given computer system includes the step of causing said client computer to use said one or more trackers to obtain said one or more subsets from the server computer.
